(19) United States
(12) Patent Application Publication
(10) Pub. No.: US 2016/0284456 A1
(43) Pub. Date: Sep. 29, 2016

(54) MAGNETIC SWITCHING ELEMENT IN A MAGNETIC CIRCUIT ARRANGED IN A DEFINED MANNER INCLUDING INDUCTOR COIL AND METHOD FOR PROVIDING ELECTRICAL ENERGY

(71) Applicant: FRAUNHOFER-GESELLSCHAFT ZUR FÖRDERUNG DER ANGEWANDTEN FORSCHUNG E.V., München (DE)

(72) Inventors: Holger LAUSCH, Jena (DE); Michael BRAND, Jena (DE); Michael ARNOLD, Jena (DE)

(21) Appl. No.: 14/777,795

(22) PCT Filed: Mar. 20, 2014
(86) PCT No.: PCT/DE2014/100095

§ 371 Date: Sep. 17, 2015

(30) Foreign Application Priority Data
Mar. 20, 2013 (DE) 10 2013 102 830.6

(51) Int. Cl. H01F 7/02; H02N 11/00; H02J 7/02; H01H 36/00

(52) U.S. Cl. CPC H01F 7/0231; H01H 36/0073; H02N 11/002; H02J 7/025

(57) ABSTRACT

The invention relates to a magnetically effective switching element for changing, in a targeted manner, the resultant effective permeability in defined regions of magnetic circuits and magnetically effective arrangements for the topical provision of energy. The magnetic switching element (1) according to the invention can be used in a magnetic working circuit. The topical provision of electrical energy is made possible by means of such a magnetic working circuit, wherein the magnetic switching element (1) is switchable without contact and in a precise manner by an externally generated magnetic field.

The invention relates to a magnetically effective switching element for the targeted change in the resultant effective permeability in defined regions of magnetic circuits and magnetically effective arrangements for the topical provision of energy.

In recent years, medical engineering has miniaturized and integrated ever more electronically controlled, functional technical units. This extends from microfluidic transport systems such as micro-pumps and pacemaker systems, to systems stimulating the cell growth in mechanical, electrical and magnetic manner. Similar requirements also apply to the field of online/inside micro/nano-integrated process metrology operated with autonomous energy (biotechnology and environmental technology, pharmaceutics, chemistry and ceramic industry).

What is common to these systems is that, for the operation thereof, energy must be available over a relatively long period of time without cables. Conventionally, the energy is provided by integrated rechargeable batteries. These rechargeable batteries need to be recharged from time to time. However, the surrounding conditions in situ can have a significant effect on their energy efficiency and therefore on the recharging or replacement cycles. In the medical field, a first disadvantage thereof is a temporary rest phase of the patient. Secondly, electronic systems and rechargeable batteries integrated deep into the body or the bone, e.g. for electrostimulation purposes, can only be supplied with energy by way of high energy densities and high losses using the conventional inductive method. In process metrology, there is a disadvantage in the still/outage times and the partial unreachability of the sensors and actuators.

However, in recent times, the aforementioned sensor/actuator systems were developed in such a way that these have been miniaturized further, become very powerful, have high levels of efficiency and can make do with low energy densities. In some cases, energy densities of only a few mW/cm² are required. It is for this reason that the market is currently seeking efficient energy transmission and/or harvesting systems, which transmit the small amounts of required energy to the integrated systems from the outside without high losses. The currently available harvesters, or harvesters in development, require temperature gradients or mechanical vibrations at the location of the sensor; however, these can generally also have a significant influence on the measurement results and the measurement methods. The conventional inductive charge systems are disadvantageous in that the efficiency has a strong dependence on distance and there is a generation of significant interference fields.

In other cases, the industry seeks for energy-autonomous sensor systems, which are used in systems engineering. In the case of active sensors, there are the same problems as in the aforementioned case of medical engineering. Downtimes of installations are intended to be avoided, even if these are only brief. Systems which transmit energy wirelessly to rechargeable batteries, which ultimately supply energy to the sensor, can represent a permanent and effective solution to these problems. Here too, the conventional inductive charging systems have the aforementioned disadvantages in respect of efficiency and generation of interference fields.

DE 37 32 312 A1 has disclosed a circuit which consists of two magnetic circuits. A control coil is present in one of the magnetic circuits while a permanent magnet is arranged in the other magnetic circuit. A yoke lamination core with a coil is arranged between the magnetic circuits and separated from the magnetic circuits in each case by an air gap. The air gap is filled with a metamagnetic material. The permanent magnet supplies a static magnetic flux density set in such a way that a value of the flux density lies just under a value which would cause a threshold field strength in the metamagnetic material. In this state, the metamagnetic material still has an antiferromagnetic effect. If a further magnetic field is applied by the control coil, the magnetic flux density is increased, as a result of which the metamagnetic material now has ferromagnetic properties. The magnetic circuits and the yoke lamination core with the coil are connected and there is a steep increase in the magnetization of the yoke lamination core. In the process, a voltage is induced into the coil and it can be discharged as electrical energy and used. A large change in the magnetic flux densities is controllable by a small change in the flux densities. The layers of the metamagnetic material present in the gaps serve as magnetocaloric switches, while the whole arrangement can be operated as a magnetocaloric inductor (also referred to as magnetic working circuit below).

The document DE 38 00 098 A1 depicts a magnetocaloric inductor with a compensation core for generating electrical energy, which inductor proposes an adapted magnetic circuit arrangement with permanent magnetic flux in the style of the transistor principle in DC circuits. Here, the air gap of the permanently magnetic yoke circuit is likewise filled with metamagnetic material. Additionally, compensation cores are arranged for eliminating an antiferromagnetic stray flux. Equiaxed, crystal-oriented and therefore anisotropic metamagnetic substances with single crystal properties are proposed as metamagnetic material. This magnetic flip-flop system requires an external electrical energy supply, at least for the counter-field generation and the flux interruption.

DE 10 2007 052 784 A1 presents a thermomagnetic generator for supplying an electrical load, which generator brings about a cyclical change in a magnetic flux density by means of thermal excitation of a core element arranged in a magnetic field, wherein electrical energy can be provided in a core as a result of the magnetic flux density change. What is required is a core element made of a metamagnetic material, which is introduced into the magnetic field in a temperature-dependent varying manner. Lanthanides such as gadolinium, dysprosium, holmium, erbium and terbium, as well as lanthanide particles dissolved in fluids are proposed as core material. The magnetic overall state of these materials has ferromagnetic and antiferromagnetic components. The operating temperature is set in such a way that the temperature-dependent entropy maximum lies between two alternating operating temperatures. It is specified as being advantageous that the coil longitudinal axis is aligned substantially parallel to the magnetic field or that the coil or coil longitudinal axis is aligned parallel to the field line profile of the field lines penetrating the latter. In contrast to the other methods presented here, no electrical energy is supplied from the outside. However, a thermal gradient in the form of a coupled thermal media circuit or a heat exchange is necessary in a targeted manner here and must be introduced. A displaceability of the core element in this case serves predominantly for the adaptation to thermally different fluid or medium flows or regions.

A disadvantage of all the aforementioned solutions is that a limited temperature range is predefined when using magnetocaloric materials and the threshold field strength for the field-dependent transition into the ferromagnetic phase (switching threshold) is at very high field strengths (>2 T) in the case of antiferromagnetic materials.

Hence, there is a demand for a wireless and contactless energy supply for microscale/nanoscale mono-/multi-sensor/actuator systems, in particular for process metrology and for diagnostic systems for medical engineering, which
avoid cross sensitivities at the location of the electrical load in the form of sensors/actuators by virtue of no interfering electrical fields being emitted,
make do without moving mass components (stationary property) at the location of the electrical load in the form of sensors/actuators,
guarantee operation in the adjusted state at the location of the electrical load in the form of sensors/actuators,
operate as energy harvesters at the location of the electrical load in the form of sensors/actuators and
pickup and make usable from an energetic point of view a defined gradient, which is either produced or present, in a wireless and contactless and spatially dislocated manner at the location of the electrical load in the form of sensors/actuators

In general, temperature, humidity, air pressure, electric field and/or magnetic field are known as the most important physical cross sensitivities as these influence the conductivities of the sensor components.

The invention is based on the object of proposing a magnetically effective switching element for the targeted change in the resultant effective permeability in defined regions of magnetic circuits and magnetically effective arrangements for topical provision of energy. The invention is moreover based on the object of proposing an improved option for providing electrical energy without cross sensitivity moments.

The objects are achieved by the subjects of the independent claims. Advantageous embodiments are specified in the dependent claims.

To this end, the invention proposes a magnetically effective switching element, which makes a magnetic alternating/rotating field gradient energetically usable. Externally generated magnetic alternating/rotating field gradients are coupled into the magnetic circuit in a wireless and contactless manner and a topical change in permeability in the switching region of the magnetic circuit is brought about.

An induction region is understood to mean a region of the magnetic circuit at which a maximum magnetic flux change can be achieved in relation to the magnetic circuit. Therefore, these regions are particularly well-suited for inductive use, i.e. for generating electrical energy by induction.

A permeability region contains materials with different magnetic properties, for example different magnetic permeabilities. The working point of this material is shifted by a change in permeability, as will be explained in detail below.

A magnet is preferably arranged at a permanent magnetic region, by means of which magnet a magnetic field of the magnetic circuit is provided.

Antiferromagnetic materials can be designed in an application-specific manner and for a broad temperature range. The layering of different antiferromagnetic, ferromagnetic and paramagnetic materials or the subdividing of the material into such regions enables use at relatively low switching thresholds/field strengths.

The invention is essentially determined by a magnetically effective switching element for the targeted change in the resultant effective permeability in defined regions of magnetic circuits and magnetically effective arrangements for topical provision of energy.

The magnetically effective switching element according to the invention for targeted change in the resultant effective permeability in defined regions of magnetic circuits and magnetically effective arrangements (also abbreviated as magnetic circuit below) for the topical provision of energy is not a second type perpetuum mobile or a system for obtaining “free energy”, but rather a wireless and contactless option of providing energy by means of a magnetically effective switching element in a magnetic circuit with an integrated permanent magnet and inductor coils on the one side, as well as a spatially separated, topically placeable, alignable and parameterizable magnetic alternating/rotating field source, which is preferably operated electrically and reacts in a load-dependent manner. That is to say, changes in loads of the electrical load (electrical consumer) downstream of an induction coil, arranged at an induction region, in the magnetic circuit lead to load changes at the external electrical, coil or permanent magnetic field generation.

Every load and every change in load necessarily leads to magnetocaloric effects which can be used thermodynamically.

The energy which can be transmitted to the magnetic circuit from the outside in a wireless and contactless and largely barrier-free (except for very ferromagnetic barriers) manner or the energy which can be generated in the magnetic circuit including the inductor coil depends, firstly, on the switchable material-specific and arrangement-dependent magnetic flux change potential and, secondly, on the externally appliable switching frequency.

The basic method of operation of the magnetic switch in the magnetic circuit is described below.

### Permanent Magnets in Magnetic Circuits

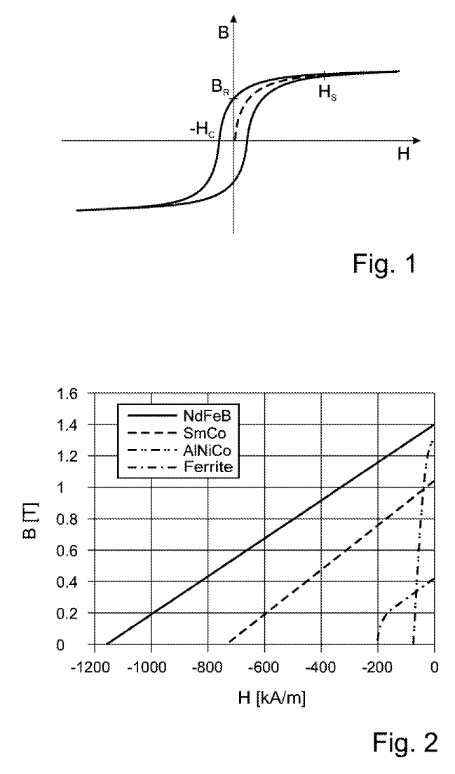

If magnetic material without remanent macroscopic magnetization is brought into an external magnetic field which increases in terms of magnitude, the magnetization initially increases in accordance with the initial curve of the material in a generally nonlinear fashion (FIG. 1; dashed curve). Once the saturation magnetization Hₛ of the material has been reached, the flux density in the material only still increases proportionately with the field strength of the external magnetic field. The factor of proportionality is μ₀, the permeability of vacuum. If the magnetic material is a permanent magnetic material such as e.g. neodymium-iron-boron, a strong remanent magnetization remains after the external field is switched off. Superficial reading may suggest that the permanent magnet produced then is situated at the remanence point (B,H)=(Bᵣ, 0) after removal of the initial external field. However, the remanence flux density Bᵣ would only be achieved in the magnet if the latter is situated in a lossless magnetic circuit. However, in all real situations there always are magnetic stray losses caused by the material. Moreover, each practically relevant application case requires an operating gap or region, at which the magnetic circuit is interrupted or otherwise modified. Therefore, in reality, a combination (B, H)=(B_{A}, H_{A}) of flux density B and field strength H sets-in when using permanent magnets, which lies on the hysteresis curve of the material, the so-called demagnetization curve, in the second quadrant of the (B, H)-coordinate system and which is referred to as working point of the magnet. The cause of this lies in the formation of poles at the surface of the magnet due to the change in the relative permeabilities μᵣ at the boundaries to adjacent materials, or else to the vacuum. This pole distribution brings about a field, directed in the opposite direction in relation to the magnetization direction, in the interior of the magnet and thereby reduces the flux density in the magnet in accordance with the demagnetization curves. FIG. 2 shows typical demagnetization curves of some conventional magnetic substances.

Many hard magnetic substances such as e.g. neodymium-iron-boron and samarium-cobalt practically have a constant “fixed” magnetization M and have a quasi-linear demagnetization curve. This can be shown using the example of the neodymium-iron-boron with the constitutive equation. The following applies:

μ₀M=B−μ₀H,

where
μ₀=permeability of vacuum (4π·10⁻⁷ Vs/Am)
M=magnetization
B=magnetic flux density
H=magnetic field strength.

For (B, H)=(Bᵣ, 0)=(1.4 T, 0 kA/m), the following is obtained:

μ₀M=1.4 T.

Similarly, for (B, H)=(0, H_{c})=(0 T, −1130 kA/m),

μ₀M=1.4 T.

also follows.

Under the assumption of a linear demagnetization curve,

$${μ}_{r} = \frac{Δ B}{Δ ( {μ}_{0} H )} \approx \frac{{B}_{r}}{{μ}_{0} {H}_{c}} \approx 1$$

is obtained for the relative permeability of the neodymium-iron-boron.

Therefore, permanent magnets with a fixed magnetization behave almost like air or vacuum when situated in the magnetic circuit.

### Load Line and Working Point of Magnets

As already described above, a negative field strength prevails in the magnet. This can be explained by the constitutive equation and Ampère's circuital law. This means, firstly, the constitutive equation \vec{B}=μ₀ (\vec{M}+\vec{H}) applies. Accordingly, since Mₐᵢᵣ=0, the following applies in the airspace outside of the magnet:

\vec{B}ₐ=μ₀\vec{H}_{c},

i.e. the \vec{B}- and \vec{H}-fields look the same there. This can no longer apply in the interior of the magnet, since the following is obtained there:

\vec{B}ᵢ=μ₀(\vec{H}ᵢ+\vec{M}).

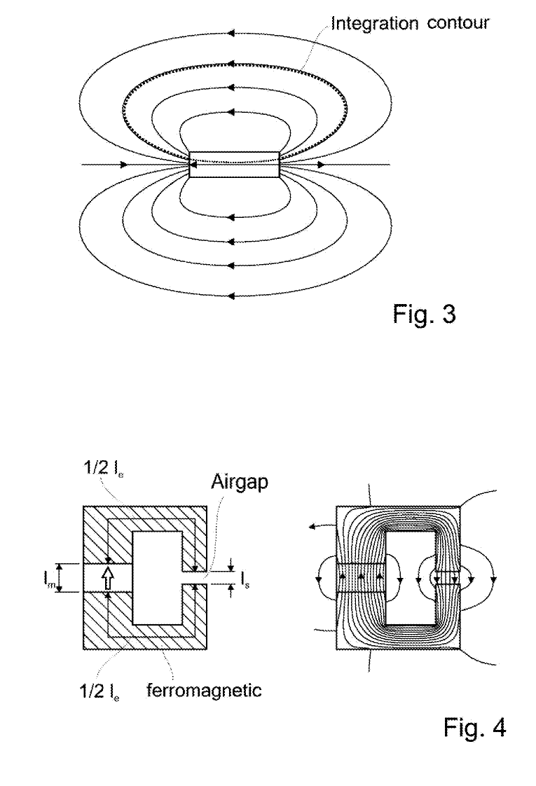

The \vec{B}-field does not have any sources, i.e. the field lines are closed. This no longer applies to the \vec{H}-field in the presence of a magnet (FIG. 3). Thus, from Ampère's circuital law

[symbol]

\vec{H}d\vec{s}=Θ

where:
Θ—magnetomotive force
d\vec{s}—line element
[symbol] —contour integral,
   applied to a circuit which is a \vec{B}ₐ- or \vec{H}ₐ-field line outside of the magnet, what follows due to the absence of electric currents and therefore Θ=0 is that external internal

[symbol]

\vec{H}d\vec{s}= [symbol] ₑₓₜₑᵣₙₐₗ\vec{H}ₐd\vec{s}+ [symbol] ᵢₙₜₑᵣₙₐₗ\vec{H}ᵢd\vec{s}=0

[symbol]

[symbol]

ₑₓₜₑᵣₙₐₗ\vec{H}ₐd\vec{s}=− [symbol] ᵢₙₜₑᵣₙₐₗ\vec{H}ᵢd\vec{s}.

Thus, the \vec{H}ᵢ-field demagnetizes the magnet such that it no longer operates at the remanence point but at a “lower” point in the demagnetization curve.

In order to determine the working point of a magnet, the whole magnetic circuit and the surroundings of the magnet need to be taken into account. FIG. 4 shows an unbranched magnetic circuit with an air gap (left-hand figure) and the field lines of the magnetic flux density (right-hand figure). It is possible to identify a concentration of the flux within the circuit, but also stray fluxes across the air gap and the magnet.

The left-hand side of FIG. 4 shows the mean lengths of the magnet Iₘ, of the iron path Iₑ and of the air gap Iₛ. The right-hand side of FIG. 4 schematically shows the profiles of magnetic field lines. Using these designations, the following follows from Ampère's circuital law:

Hₘ·Iₘ+Hₑ·Iₑ+Hₛ·Iₛ=Θ

and, furthermore, due to the lack of electric currents (Θ=0):

Hₘ·Iₘ+Hₑ·Iₑ+Hₛ·Iₛ=0

where Hₘ-field strength in the magnet, Hₑ-field strength in the iron path and Hₛ-field strength in the air gap. The terms H_{[ ]}·I_{[ ]} can be interpreted as magnetic “voltage drops” over the respective regions of the magnetic circuit.

Since, in general, the following applies for the permeability μₑ of the iron path: μₑ>>μ₀, the term Hₑ·Iₑ can be neglected to a first approximation. Thus, the following applies:

Hₘ·Iₘ+Hₛ·Iₛ=0

If Aₘ and Aₛ denote the mean cross-sectional areas of the magnet and of the air gap and Bₘ and Bₛ the respective flux densities in the magnet and in the air gap, then the associated magnetic fluxes Θₘ and Θₛ in the magnet and in the air gap emerge as:

Θₘ=Bₘ·Aₘ

Θₛ=Bₛ·Aₐ.

Due to the stray losses of the magnetic circuit, the magnetic flux in the air gap is never as large as the flux in the magnet. This is taken into account by way of a scattering factor kₛ, where 0<kₛ≦1. Thus, the following is obtained:

$${B}_{s} \cdot {A}_{s} = {k}_{s} \cdot {B}_{m} \cdot {A}_{m} ⇔ \\ {B}_{s} = \frac{{k}_{s} \cdot {B}_{m} \cdot {A}_{m}}{{A}_{s}} .$$

Then, the following equation emerges for the field strength of the magnet, with Hₛ=Bₛ/μ₀:

$${H}_{m} = - \frac{{H}_{s} \cdot {I}_{s}}{{I}_{m}} = - {k}_{s} \cdot \frac{{I}_{s}}{{I}_{m}} \cdot \frac{{A}_{m}}{{A}_{s}} \cdot \frac{{B}_{m}}{{μ}_{0}} .$$

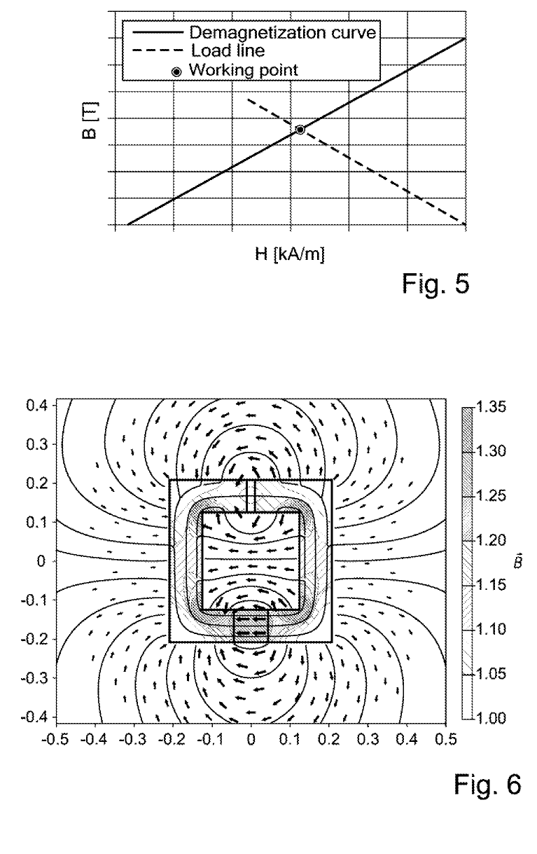

This is the equation of the so-called load line. The working point of the magnet in the considered magnetic circuit therefore emerges as the intersection of the load line and the demagnetization curve of the magnet (cf. FIG. 5).

The flux density in the magnet emerges from the constitutive equation:

Bₘ=μ₀(Hₘ+Mᵣ)=μ₀Hₘ+μ₀Mᵣ=μ₀Hₘ+Bᵣ,

with the remanent magnetization Mᵣ and the remanent flux density Bᵣ. In the case of a fixed magnetization (see above), the magnetization is not dependent on the field strength and the demagnetization curve is linear. The working point (Bₘ, Hₘ) of the magnet then emerges as the intersection between two straight lines, and the following is obtained:

$${H}_{m} = - \frac{{k}_{s} \cdot {I}_{s} \cdot {A}_{m}}{{k}_{s} \cdot {I}_{s} \cdot {A}_{m} + {I}_{m} \cdot {A}_{s}} \cdot \frac{{B}_{r}}{{μ}_{0}}$$

$${B}_{m} = {μ}_{0} {H}_{m} + {B}_{r}$$

### EXAMPLE

The following emerges for the field strength in the magnet for a 10×10×10 mm³ neodymium-iron-boron magnet (Bᵣ=1.4 T) in a highly permeable yoke (μᵣ=∞) with an air gap 1 mm in length, when the stray losses are neglected (kₛ=1) and the assumption of constant cross sections (Aₘ=Aₛ=100 mm²) is made:

$${H}_{m} = - \frac{{k}_{s} \cdot {I}_{s} \cdot {A}_{m}}{{k}_{s} \cdot {I}_{s} \cdot {A}_{m} + {I}_{m} \cdot {A}_{s}} \cdot \frac{{B}_{r}}{{μ}_{0}} ⇔ \\ {H}_{m} = - \frac{1.1 mm \cdot 100 {mm}^{2}}{1.1 mm \cdot 100 {mm}^{2} + 10 mm \cdot 100 {mm}^{2}} \cdot \frac{1.4 T}{4 π \cdot {10}^{- 7} \frac{Vs}{Am}} ⇔ \\ {H}_{m} = - 101.28 kA \text{/} m .$$

The following emerges for the flux density in the magnet:

Bₘ=μ₀Hₘ+Bᵣ

[symbol]

Bₘ=4π·10⁻⁷ Vs/Am·(−101280 A/m)+1.4 T

[symbol]

Bₘ=1.27 T

The working point of the magnet in the highly permeable magnetic circuit with air gap therefore lies at

(Bₘ,Hₘ)=(1.27 T,−101.28 kA/m).

### Consequences for the Magnetically Effective Switching Element

If the air gap were to be closed by a highly permeable material (μᵣ=∞), what follows with Iₛ=0 from

$${H}_{m} = - \frac{{k}_{s} \cdot {I}_{s} \cdot {A}_{m}}{{k}_{s} \cdot {I}_{s} \cdot {A}_{m} + {I}_{m} \cdot {A}_{s}} \cdot \frac{{B}_{r}}{{μ}_{0}} = 0 ,$$

is that there is no field within the magnet. Thus, the following would apply:

Bₘ=μ₀Hₘ+Bᵣ=μ₀·0+Bᵣ=Bᵣ.

In this case, the working point of the magnet lies at the remanence point (Bᵣ,0).

If the stray flux is neglected, the flux Θ=∫BᵣdA would prevail in the whole magnetic circuit; in the above example thus at Θ=1.4 T·0.01 m²=1.4·10⁻⁴ Vs.

When the switch is made from μᵣ=∞ to μᵣ=1, the flux in the magnetic circuit would drop to the value of Θ=1.27 T·0.01 m²=1.27·10⁻⁴ Vs calculated above. The difference in the flux of Θ=1.3·10⁻⁵ Vs corresponds to the usable flux change. If μᵣ is not modified from the only theoretically achievable values of μᵣ=∞ to μᵣ=1, but rather from μᵣ=μ₁ to μᵣ=μ₂ with the aid of the proposed magnetically effective switching element, with μ₁<<μ₂, then this likewise results in a usable change in the flux in the magnetic circuit. The magnetically effective switching element should be considered to be a switch for the magnetic working circuit in this sense.

### Simulation Results

In general, the field and flux density distribution in a magnetic circuit can only be determined accurately by means of numerical methods. To this end, the results of a FEM simulation using COMSOL Multiphysics 4.3, module AC/DC, are reproduced in the following. What was simulated was the unbranched magnetic circuit with a permanent magnet and a gap, as already specified above as an example, wherein the permeability in the gap was varied and, from this, the different field and flux distributions in the magnetic circuit and in the surroundings thereof were determined. A high-performance substance (e.g. neodymium-iron-boron) with a remanence flux density of Bᵣ=1.4 T and a “fixed” magnetization was assumed as magnetic material. The dimensions of the magnet were set to 10×10×10 mm³. A relative permeability of μ_{r,e}=500 was selected for the material of the iron circuit. The overall magnetic circuit had a square geometry with a mean extent of 50 mm×50 mm and a constant cross section of 10×10 mm² over the whole magnetically effective region. A two-dimensional magnetostatic model (COMSOL Multiphysics, ACDC, physics model mf—magnetic fields) was used.

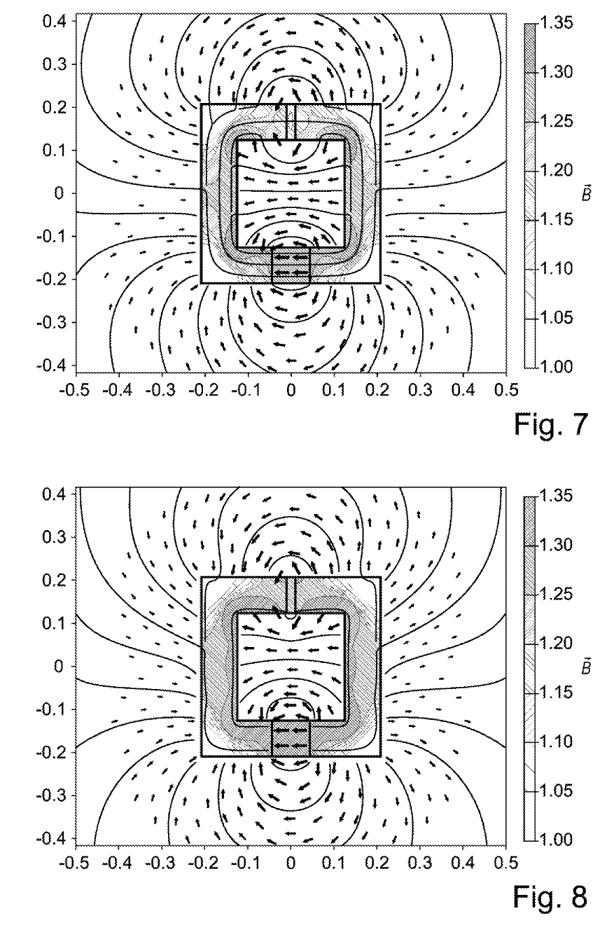

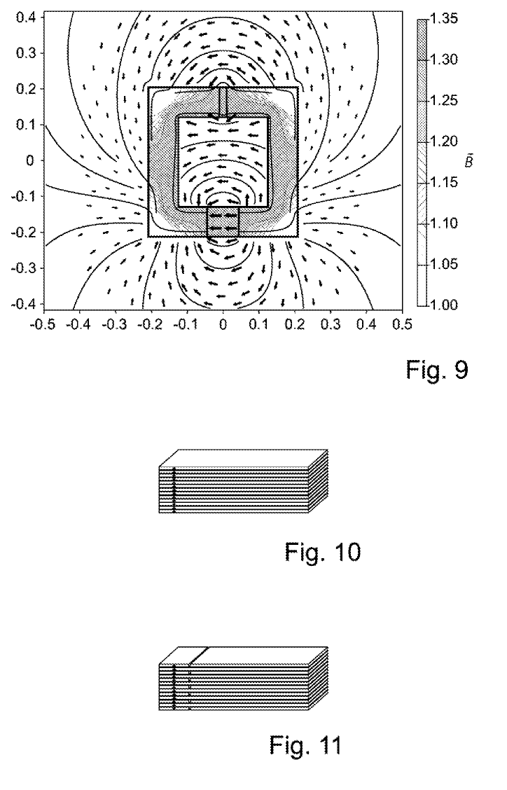

The results of the simulation in the form of the calculated field and flux density distributions are depicted in FIG. 6 to FIG. 9. The scale and grayscale value representation are identical in all four cases. It is possible to identify that the magnetic flux density (encoded by grayscale value) is increased at all points in the magnetic circuit with increasing permeability in the gap. Since the cross section does not vary, this is therefore also connected with a usable flux change. The magnetic field (encoded by arrows) decreases in parallel therewith.

### Material Combination for the Layer Structure in the Gap

The material for the magnetic switching element is a permeable material, the permeability of which e.g. corresponds to the permeability of the magnetic circuit material. This can be layered alternately with a material, the permeability of which is selected in such a way that, as a result of the effect of an external secondary magnetic field, the resultant permeability is effectively changed in the whole magnetic circuit and this leads, at least at defined points, to a change in the magnetic flux. This material sequence can be layered a number of times (FIG. 10 and FIG. 11). Here, these can be hard and soft magnetic materials.

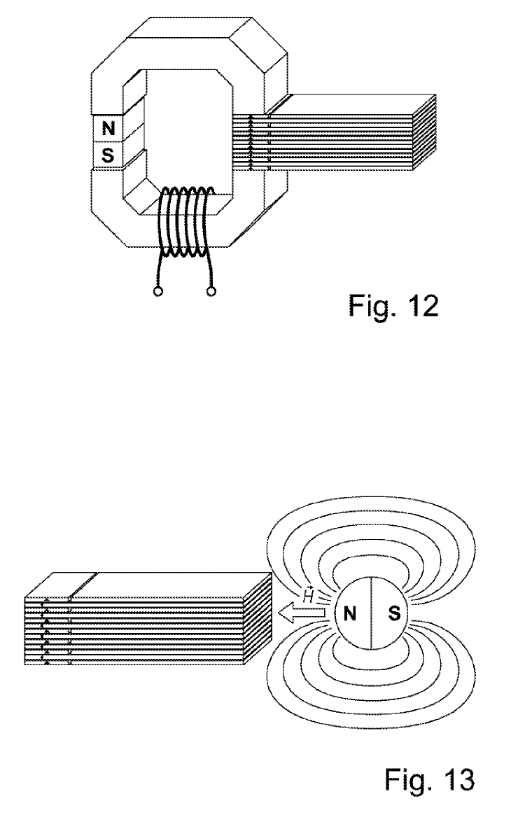

If this element is introduced into the work gap of a magnetic circuit e.g. magnetically biased by means of a permanent magnet, the resultant permeability can be controlled by means of the external magnetic field. The embodiment is advantageously configured in such a way that the gap in the magnetic circuit should be considered closed in the absence of an external magnetic field (FIG. 12). When an external magnetic field, which is e.g. generated by a rotating permanent magnet (FIG. 13), acts, the material sequence in the gap is remagnetized in such a way that the magnetic flux in the gap is obstructed. As a result, a state corresponding to a wider or narrower air gap is obtained.

The magnetic switching element is preferably formed by a material combination of layers/regions which are differently magnetizable. The different magnetizability relates e.g. to the strength of the magnetizability, the permeability of the materials and the direction/anisotropy of the magnetizability.

Use can be made of combinations of materials made of ferromagnetic, antiferromagnetic and paramagnetic materials with a more or less pronounced magnetocaloric effect.

Changes in the flux in the different regions of the magnetic circuit, e.g. in the limbs thereof and in the permanent magnets per se, also emerge from the change in the magnetic flux in the gap, which is caused by the external magnetic field.

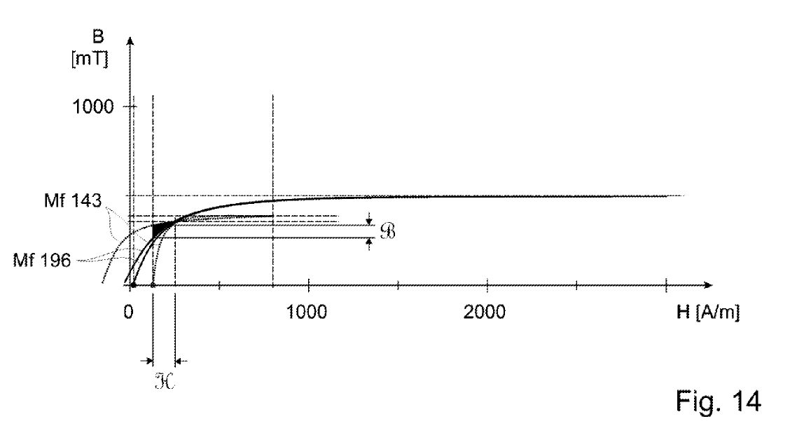

If the material sequence is a layering of hard and soft magnetic materials (hard and soft ferromagnetic materials), this corresponds to an antiferromagnetic arrangement of two materials. An example for the material selection is depicted in the following B-H diagram (FIG. 14). Mf143 and Mf196 are ferritic materials selected in an exemplary manner.

The selection of materials for the magnetic switching element designed thus is only specified here in an exemplary manner. It must be adapted to the conditions of the magnetic circuit with permanent magnets, magnetic conductors and working gap (gap). In particular, the arrangement of the material of the magnetic switching element in the working gap can also have different designs. By way of example, leading the switching element out of the working gap into the magnetic conductors in order already to focus the external magnetic field outside of the magnetic circuit is advantageous.

The switch material for the gap can be a magnetocaloric material. These materials have a high field-induced entropy difference due to an additional field-induced phase conversion. However, this limits the working temperature. Thus, for example, gadolinium (T_{c}=19.3° C.) is no longer effectively effective in a magnetocaloric manner below 6° C. and above 27° C.

A field-induced entropy change occurs in every magnetic material, in particular materials with a specific structure (cuprostibite) and layered materials with different magnetic properties. However, this is substantially lower than in the magnetocaloric materials. The layered materials are also advantageous in that this effect therein is independent of the Neel or Curie temperature.

If energy is withdrawn from the system (even in the form of electrical energy) the system must cool. The size of this effect depends strongly on the material parameters, the surrounding conditions and the method of operation (frequency of the external field change). The ratio thereof to the thermal increase by way of counter induction of a loaded coil and may therefore be positive and negative.

The magnetocaloric effect is understood to mean the property of some materials of heating up under the effect of a magnetic field. If the magnetic field is weakened again, or completely removed, the material cools down again. Simply put, this effect is achieved by an alignment (increase in order) of the magnetic moments of the material when a strong magnetic field is applied. When the magnetic field is removed, the order decreases, i.e. the degree of alignment of the magnetic moments reduces again (see e.g. Stocker, H., Taschenbuch der Physik [“Handbook of Physics”], 4^{th} edition). A good overview of this topic is provided by Fähler et al. (2012, Advanced Engineering Materials 14: 10-19).

The magnetic properties of the material are also influenced and temporarily modified by the alignment of the magnetic moments. An important variable that can be influenced in a targeted manner is the magnetic flux density present in the material. By way of example, a controlled change in the magnetic flux density enables the use of a magnetocaloric material for controlling electrical circuits.

The intensity of the magnetic flux in the magnetic circuit is possible by varying the arrangement of the magnetically effective switching elements. Here, the arrangement of the magnetic switching elements can be varied e.g. in terms of their number and their spatial arrangement in the magnetic circuit.

It is also possible to influence the intensity of the magnetic flux in the magnetic circuit by way of the geometric design of the magnetic circuit/the magnetically effective arrangement. By way of example, the magnetic circuit can be designed as an unbranched or a branched magnetic circuit. Moreover, the number and spatial arrangement of the working gaps (gaps) can be varied.

The magnetic switching element according to the invention consists of a layer/region sequence of layers stacked above one another or regions arranged next to one another. Preferably, the regions or layers consist of at least one first ferromagnetically hard material with a first saturation flux density, at least one second antiferromagnetic or ferromagnetically soft material and at least one third ferromagnetically hard material with a third saturation flux density. The first and third material can be identical. The first and third material can also be homogeneous in further embodiments of the invention, e.g. have similar magnetic properties.

In further advantageous arrangements, the first and third material coincide with the magnetic circuit material. In all cases, use can be made of materials with anisotropic magnetic properties with different alignments and arrangements in relation to the magnetic circuit.

A plurality of sequences of the first, second and third material, for example in the form of a layering, can be arranged in specific embodiment variants of the magnetic switching element according to the invention.

The saturation flux density is understood to mean that magnetic flux density which sets-in in a material if the latter reaches the saturation magnetization thereof as a result of a magnetic field acting thereon.

In an advantageous arrangement embodiment, the respective saturation flux densities within a material sequence, e.g. the saturation flux density of the first and second material, differ from one another. Here, the first saturation flux density always has higher values than the second saturation flux density. Materials with mutually different saturation flux densities within the meaning of the description are e.g. lanthanum-strontium-manganese oxides (La—Sr—MnO, LSMO) with different lanthanum/strontium ratios or magnesium-copper-zinc ferrites (Mg—Cu—Zn-ferrites) with different copper/magnesium ratios.

In a layer sequence, e.g. as described above, of magnetically hard-soft-hard materials, the values for the first saturation flux density preferably lie in a range from 400 to 600 mT, while the values for the second saturation flux density lie in a range from 500 to 1000 mT. In this case, it is important to the invention that the material of the first ferromagnetic layer already reaches a saturation flux density at lower magnetic field strengths than the respectively selected material for the second ferromagnetic layer. The value of the third saturation flux density for the third layer in turn preferably lies in a range from 400 to 600 mT. This layer/region sequence therefore constitutes an antiferromagnetic layer/region sequence.

In a preferred embodiment of the switch according to the invention, the antiferromagnetic layer/region sequence can be repeated a number of times, constructed in the form of a laminate. One of the antiferromagnetic layer/region sequences should preferably be embodied with a thickness of 100 to 300 μm.

What can advantageously be achieved by the magnetic switching element according to the invention, for example in the form of an antiferromagnetic layer/region sequence, is that the magnetic flux in the whole magnetic circuit can be switched or modified in a defined manner over large distances. As a result of the interaction and the arrangement of all materials of the switching element and the advantageous field-focusing integration into the magnetic circuit, a sensitive, precisely controllable magnetic switch is created.

The effect of the material sequence of the switching element according to the invention is also increased by virtue of the layers/regions extending in planes that preferably extend orthogonally to the faces of the working gap of the magnetic circuit, e.g. the layers of a ferritic laminate of a yoke, in which the switching element according to the invention is operated. As a result of a mutually orthogonally aligned arrangement, the effects of magnetization processes (both magnetization and demagnetization) in an arrangement of switching element and device interact particularly effectively with one another.

The material of the magnetic conductors can preferably be a ferritic laminate, for example consisting of 50 films, each with a thickness of 100 μm. The ferritic laminate can be sintered. After a sintering process, the ferritic laminate e.g. has a height of 5 mm. What is advantageously achieved thereby is that eddy currents are avoided and the cross sensitivity of the downstream electrical loads is influenced in a negative fashion.

A magnetic circuit with a switching element according to the invention can be installed together with an inductor coil which converts the magnetic flux changes into electrical energy and feeds the latter to the load. An advantageous arrangement of magnetic circuit with an induction coil has a magnetic circuit subdivided into yoke portions by a first gap and a second gap. Here, the first gap and the second gap are respectively delimited by the end faces of the yoke portions. The arrangement is characterized by a magnetic switching element according to the invention being arranged in the first gap. The layers/regions of the magnetic switching element are arranged parallel to the end faces of the yoke portions delimiting the first gap. Moreover, a permanent magnet is arranged in the second gap. The induction coil is advantageously arranged in regions of the yoke portions with large flux changes. The embodiment of the inductor coil can be brought about in a manner wound about the yoke limbs and also in a planar manner in defined planes.

As a result of a magnetic field caused by the permanent magnet and focused by the yoke portions, the magnetic circuit is at a first working point which is characterized by the prevalent flux densities and the corresponding field strengths. The application of an external magnetic field and the change in the permeability in the switching element accompanying this brings about a shift in the magnetic conditions in the whole magnetic circuit to a second working point. The difference in the flux densities between first and second working point, as a flux change, can be converted inductively into electrically usable energy. It is advantageous if the magnetic switching element is kept near a working point with a strong increase in the demagnetization curve by way of the selection of the dimensions, the magnetic properties and the spatial location of the permanent magnet in the magnetic circuit as well as by way of considering interactions between the permanent magnet and yoke portions. As it were, the switching element is already magnetically biased as a result of the action of the permanent magnet.

The magnetic circuit including permanent magnet, inductor coil and switching element can be produced wholly or in part using LTCC (low temperature cofired ceramic) technology. The whole arrangement can be integrated into single or multi-layer carrier materials (base laminate) made of a dielectric material, e.g. barium titanate, which can be sintered with the magnetically or inductively effective materials, likewise in the LTCC method.

Advantageously, no moveable parts or additional external electronic control pulses are required for carrying out the switching function. Switching the magnetic switch according to the invention is brought about by an appropriately configured alternating external magnetic field (magnetic field outside).

The object is furthermore achieved by an arrangement of a magnetic circuit including magnetic switching element, inductor coil and permanent magnet and a device for producing a second changing magnetic field, wherein the device for producing the second changing magnetic field is arranged in such a way that at least the magnetic switching element can be penetrated by magnetic field lines from the second changing magnetic field and the properties of the second changing magnetic field are selected in such a way that driving to the first and second working point is ensured, preferably periodically or in an alternating manner. What is tantamount to this is that the second changing magnetic field in the arrangement according to the invention changes the resultant permeability of the magnetic circuit in a spatial-temporal manner. Ultimately, an electrical voltage is induced in the inductor coil as a result of the effect of the changing flux densities in the magnetic circuit.

The second changing (external, outside) magnetic field can be realized by e.g. a rotating strong permanent magnet magnetized in a diametric manner. The distance between the external, rotating permanent magnet and the above-described magnetic switch is dependent on the dimensioning of the permanent magnet in the magnetic circuit and of the external rotating permanent magnet. A desired distance between external rotating permanent magnet and the magnetic switch can be set by selecting the magnetic properties. A rotating magnetic field is produced due to the rotation of the permanent magnet. If the magnetic switching element is situated at a specific location of the rotating magnetic field it is exposed to a magnetic field that changes in terms of direction and magnitude. As a result, a remagnetization of the layers/regions of the switching element is brought about in the case of appropriate dimensioning of the permanent magnet in the magnetic circuit and the permanent magnet producing the rotating external field, as a result of which the switching effect is generated. No spatially moving parts or excitation voltages are required at the location of the switching element.

The usable energy originates from the magnetically imparted energy of the external field (e.g. energy uptake of the motor for driving the permanent magnet or current uptake of a coil arrangement for producing an electric field) and possibly from thermal components caused by magnetocaloric effects in the involved materials (magnetic circuit and switching element). Within this meaning, the arrangement according to the invention is an energy harvester within the meaning of a transducer which converts introduced or resultant gradients.

As a result of the switching, a constant change in the magnetic flux is achieved in the coil as a transducer, situated at the magnetic circuit (or in the coils situated at the magnetic circuit). The voltage is determined by the frequency of the remagnetization (pulse duration, increasing flank of the flux change).

The strength of the field prevalent at the switching element determines the flux density in the whole magnetic circuit. Therefore the load behavior can be dimensioned by the material selection, the geometric arrangement of the magnetic conductors and the working gaps (position and number), as well as the amount of material contained therein.

A contactless and wireless operation of a magnetic flux-switching or magnetic flux-controlling arrangement can be brought about by means of the external magnetic field. Here, the external magnetic field can be a rotating field, a field alternating in a defined manner in terms of direction or else an irregularly varying field.

The external field can be provided explicitly, e.g. by a motor/a drive with a permanent magnet or by an electrically generated magnetic field, or, in the case of at least temporary existence, it can also be picked up from the surroundings. The latter option constitutes energy harvesting within the meaning of picking up introduced or existing magnetic gradients.

The topical provision of energy is also ensured by the arrangement according to the invention of a per se static magnetic working circuit comprising a magnetic switching element and an external dynamic magnetic field production. Here, the provision and transmission of energy is primarily realized by the external magnetic field production and the conversion by the magnetic working circuit comprising magnetic switching element and inductor coil. The magnetic switching element makes the per se static magnetic working circuit dynamic, as a result of which the latter becomes an energy transducer.

Moreover, the autonomous energetically effective magnetic circuit can be influenced in terms of power in a defined manner by way of the externally controllable switching frequency.

Below the invention will be described in more detail on the basis of exemplary embodiments and figures. In detail:

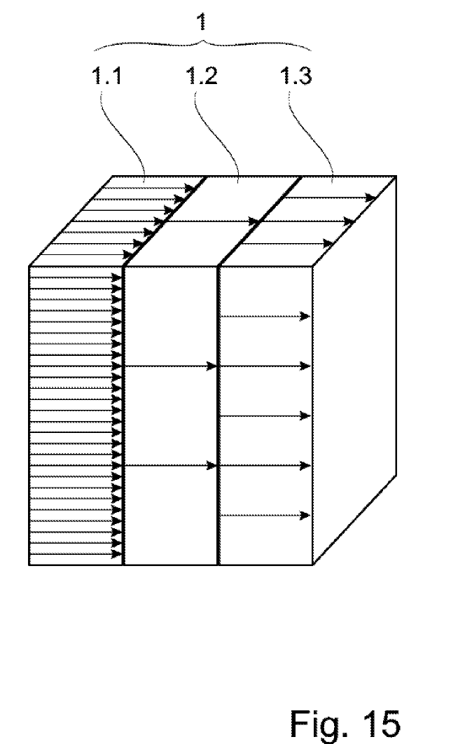

FIG. 15 shows a schematic illustration of a first exemplary embodiment of a magnetic switch according to the invention with magnetic field lines,

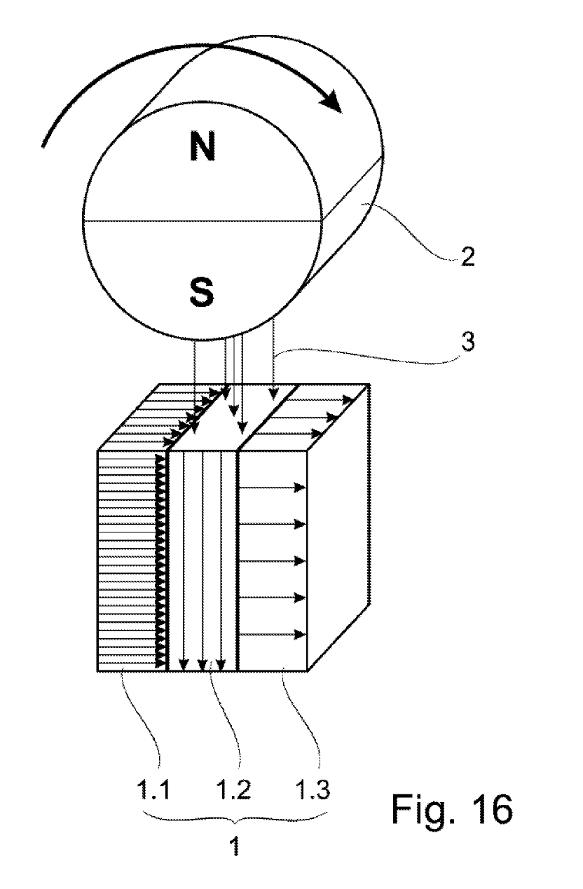

FIG. 16 shows a schematic illustration of the first exemplary embodiment of a magnetic switch according to the invention with magnetic field lines when a magnetic field acts thereon,

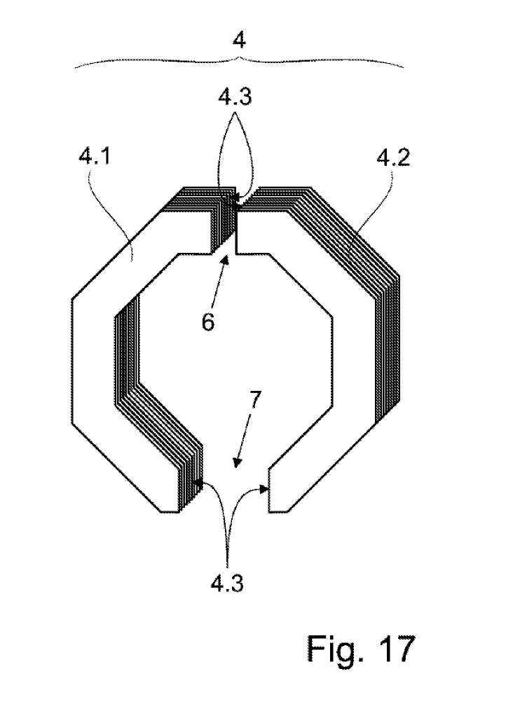

FIG. 17 shows a first exemplary embodiment of a yoke with two yoke portions,

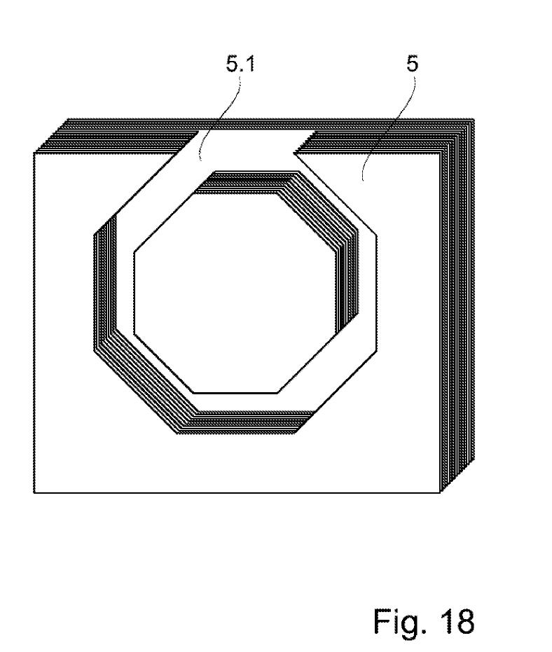

FIG. 18 shows a first exemplary embodiment of a base laminate for a yoke,

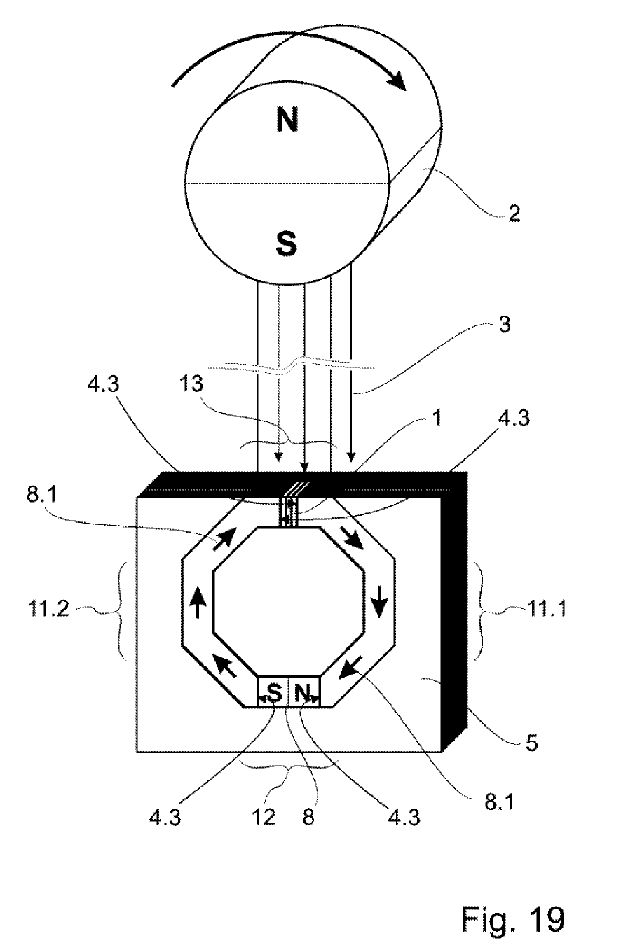

FIG. 19 shows a first exemplary embodiment of a magnetic working circuit according to the invention,

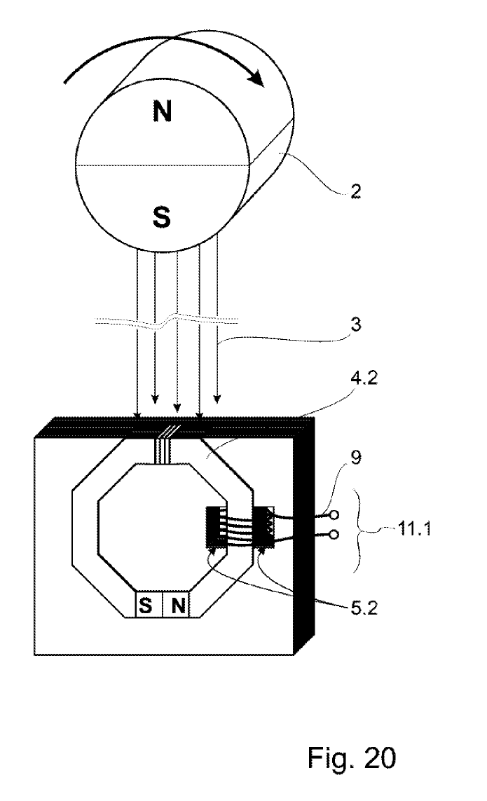

FIG. 20 shows a second exemplary embodiment of a magnetic working circuit according to the invention and a rotating permanent magnet and an inductor coil,

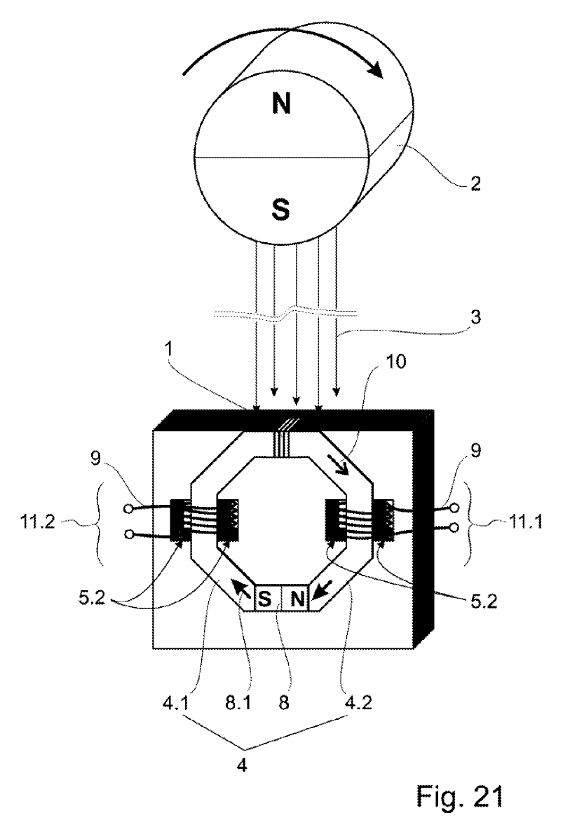

FIG. 21 shows a third exemplary embodiment of a magnetic working circuit according to the invention.

The essential elements of a magnetic switching element 1 according to the invention are a first ferromagnetically hard layer 1.1, a second ferromagnetically soft layer 1.2 and a third ferromagnetically hard layer 1.3 (FIG. 15).

The second ferromagnetic layer 1.2 is arranged between the two ferromagnetic layers 1.1 and 1.3. All three layers 1.1 to 1.3 adjoin one another directly and are aligned parallel to one another. The first ferromagnetic layer 1.1 consists of a material with ferromagnetic properties, which has a first saturation flux density of 600 mT. The second ferromagnetic layer 1.2 consists of a material which has a second saturation flux density of 1000 mT. The material of the third ferromagnetic layer 1.3 has a third saturation flux density of 500 mT.

FIG. 16 shows the same switching element 1 as in FIG. 15. However, there additionally is a rotating permanent magnet 2 in the form of a cylinder, which is rotatable about the longitudinal axis thereof. A second changing magnetic field 3 (some of the magnetic field lines thereof are indicated by arrows) is produced as a result of the movement of the rotating permanent magnet 2 (direction of rotation shown by a curved arrow). The rotating permanent magnet 2 is arranged in such a way that magnetic field lines of the second changing magnetic field 3 act at least on the first to third layer 1.1, 1.2, 1.3.

The functionality of the magnetic switching element 1 (also abbreviated to: switch 1) is explained in a simplified manner on the basis of both FIG. 15 and FIG. 16. It is assumed that the switch 1 is arranged in a magnetic field 8.1 (not shown here; see FIG. 19 and FIG. 21), the effect of which is exemplified by schematically shown magnetic field lines. The magnetic field lines are depicted by arrows in the individual layers 1.1 to 1.3. The direction of the arrows specifies, in an exemplary manner, the direction of the magnetic field lines and of the magnetic flux. The number of arrows exemplifies the magnetic flux density. The second changing magnetic field 3 is an external or outside magnetic field, the magnetic field lines of which are orthogonal to the magnetic field lines of the magnetic field 8.1 (an internal magnetic field). The magnetic field lines of the magnetic field 8.1 extend in the direction of the arrows in accordance with FIG. 15 and the arrows of the first ferromagnetic layer 1.1 or else of the third layer 1.3.

If the second changing magnetic field 3 thus acts on the first (1.1) and third (1.3) ferromagnetic layers (FIG. 16), the saturation flux densities thereof are only just not reached. Here, the resultant effective magnetization of the second ferromagnetic layer 1.2 in the direction of the magnetic working circuit is significantly reduced and it moves out of the saturation range thereof. As a result, the behavior of the material of the ferromagnetic layer sequence is changed to the extent that it effectively is less magnetically permeable. The switch is “switched off”. This change is symbolized by the changed alignment of the magnetic field lines of the second ferromagnetic layer 1.2 in FIG. 16. In this state, the second ferromagnetic layer 1.2 acts as a barrier layer in relation to the magnetic flux. When the rotating permanent magnet 2 continues to move, the influence of the second changing magnetic field 3 on the second ferromagnetic layer 1.2 changes once again. If the value of the second saturation flux density is once again exceeded as a result of a decrease in the strength of the second changing magnetic field 3, the second ferromagnetic layer 1.2 becomes magnetically permeable once again and the switch 1 is “switched on”.

A yoke 4 consisting of a first yoke portion 4.1 and a second yoke portion 4.2 is shown in FIG. 17. The first and second yoke portions 4.1, 4.2 each have an angled U-shaped design and are made of a ferritic laminate of 50 films which are made of a ferritic material, arranged parallel to one another and each have a thickness of 100 μm (indicated). Both yoke portions 4.1, 4.2 were produced by means of LTTC technology. The individual planes of the films extend along the longitudinal extent of the yoke portions 4.1, 4.2 (lamination direction). End faces 4.3, at which the layers of ferritic laminate end, are respectively present at the ends of the yoke portions 4.1, 4.2. The yoke portions 4.1, 4.2 are dimensioned in such a way that these can be arranged in relation to one another in such a way that the lamination directions of the yoke portions 4.1 and 4.2 are the same and lie opposite respectively one of the end faces 4.3 of the first yoke portion 4.1 respectively one of the end faces 4.3 of the second yoke portion 4.2.

FIG. 18 is a base laminate 5 made of layers of barium titanate, a dielectric material. The base laminate 5 has a recess 5.1, in which respectively a first and a second yoke portion 4.1, 4.2 are insertable in an interlocking manner. The recess 5.1 is designed in such a way that, when the first and second yoke portions 4.1, 4.2 are inserted, a first gap 6 and a second gap 7 remain between the mutually opposite end faces 4.3 (see FIGS. 17, 19, 20 and 21).

A base laminate 5 with inserted first and second yoke portions 4.1, 4.2 is shown in FIG. 19 as a first exemplary embodiment of a magnetic working circuit without an inductor coil. A magnetic switch 1 is arranged in the first gap 6. It completely fills the first gap 6 and, in terms of the dimensions thereof, corresponds to the end faces 4.3 adjoining it. A permanent magnet 8 is present in the second gap 7. The respective poles of said permanent magnet (denoted by “S” and by “N”) are in contact with the respectively adjoining end faces 4.3. The permanent magnet 8 causes a magnetic field 8.1, the magnetic field lines of which (symbolized by arrows) are focused and directed by the yoke 4. The magnetic field lines also penetrate the magnetic switch 1. The permanent magnet 8 is selected in such a way that the magnetic field 8.1 caused thereby causes the second saturation flux density to be reached in the second ferromagnetic layer 1.2 (not shown here, see FIGS. 15 and 16). This arrangement provides a first exemplary embodiment of a magnetic working circuit according to the invention as a principle example. Moreover, the rotating permanent magnet 2 which is arranged at a defined large distance from the magnetic circuit is present. However, the magnetic field lines of the second changing magnetic field 3 act on a permeability region 13 of the magnetic circuit, in which the magnetic switching element 1 is located. The shown magnetic working circuit has a first induction region 11.1 and a second induction region 11.2 over the laterally shown regions of the yoke 4. The permanent magnet 8 is arranged in a permanent magnetic region 12 of the magnetic circuit.

In a further embodiment of the invention, it is possible to dispense with the base laminate 5, and the first and second yoke portions 4.1, 4.2, the magnetic switch 1 and the permanent magnet 8 can be arranged in relation to one another and held by other technical means, e.g. a suitable holding structure. It is also possible for the base laminate 5 to have a different number of layers, for example at least one.

A second exemplary embodiment of a magnetic working circuit according to the invention is depicted in FIG. 20. In addition to the elements shown in FIG. 19, an electrically conductive inductor coil is present as electrically conductive element 9. Respectively one opening 5.2 through the material of the base laminate 5 is present on both sides in the base laminate 5 in the region of the center of the second yoke portion 4.2. The electrically conductive element 9 is guided through the openings 5.2 and reaches around the second yoke portion 4.2 around the first induction region 11.1. Connection lines (only indicated) are present on the electrically conductive element 9 for dissipating electrical energy induced in the electrically conductive element 9.

FIG. 21 shows a third exemplary embodiment of a magnetic working circuit according to the invention. Here too, openings 5.2 through which a further electrically conductive element 9 is guided are present in the region of the center of the first yoke portion 4.1. The rotating permanent magnet 2, the second changing magnetic field 3 of which acts on the switch 1, is arranged over the magnetic switching element 1. The rotating permanent magnet 2 constitutes a device for producing a second changing magnetic field 3.

The method according to the invention for provision of electrical energy is described in a simplified manner on the basis of FIG. 21. The permanent magnet 8 causes a magnetic field 8.1, which is focused and directed by the yoke 4. The magnetic field 8.1 is static, i.e. it is unchanging. The magnetic field 8.1 causes a magnetic flux density along magnet field lines in both the yoke 4 and the magnetic switch 1 (see FIGS. 15, 16 and 19). Although the magnetic flux density lies below the value of the second saturation flux density of the second ferromagnetic layer 1.2 (FIGS. 15 and 16), the effect of the magnetic field 8.1 already brings about a certain amount of magnetization of the material of the second ferromagnetic layer 1.2. In this state, the magnetic field lines of the magnetic circuit formed by the yoke 4, the switch 1 and the permanent magnet 8 are closed and a magnetic flux can be created in the magnetic circuit. No electrical energy (electrical voltage) is induced in the electrically conductive elements 9 at this time. If the rotating permanent magnet 2 is put into rotation, the effect of the second changing magnetic field 3 on the second ferromagnetic layer 1.2 is also changed during the rotation and the change in the second changing magnetic field 3 accompanying this. As a result, the value of the resultant effective magnetization of the second ferromagnetic layer 1.2 is reduced in the direction of the magnetic working circuit and the magnetic circuit is interrupted, as already explained above. In the case of a further change in the second changing magnetic field 3 due to the advancing rotation of the rotating permanent magnet 2, the value of the resultant effective magnetization of the second ferromagnetic layer 1.2 in the direction of the magnetic working circuit is increased again and the magnetic circuit is closed again. During further continuing rotation, the alternating opening and closing of the magnetic working circuit repeats. Switching the magnetic switch 1 on and off causes a first changing magnetic field 10 (which is merely indicated here) in the magnetic circuit, by means of which electrical voltages are respectively induced in the electrically conductive elements 9 and electrical energy can be tapped. The electrical energy that can be tapped is controllable by an appropriately controlled rotational speed of the rotating permanent magnet 2.

An electrically conductive element 9 is present at the first induction region 11.1, by means of which element generated electrical energy is tapped, as described above. A further electrically conductive element 9 is present at the second induction region 11.2, as a result of which the usable energy is increased, energy is provided for further loads or the magnetic working circuit can be e.g. conditioned electrically or thermally.

In order to establish suitable dimensions of the permanent magnet 8 in relation to the strength of the second changing magnetic field 3 of the rotating permanent magnet 2, the permanent magnet 8 is replaced by a coil. The first gap 6 is filled with different materials (air, ferromagnetic materials with different saturation flux densities, antiferromagnetic material) and different AC voltages are respectively applied to the coil (with an unchanging frequency, e.g. 50 Hz). The overall magnetization is different, depending on material and variable distance from the rotating permanent magnet 2. Only two orthogonal positions of the permanent magnet 8 are used in the experimental case. Statements can thus be made about the dimensions and the material selection to be made. The measured quantity for the magnetization is the induced voltage in the electrically conductive element or elements 9. If electrical energy is available at the location of the magnetic working circuit, the magnetic working circuit can also generally be biased with an electrically produced magnetic field.

The materials are preferably selected in such a way that the magnetic flux (from the permanent magnet 8, over the yoke 4 and through the first gap 6) is interrupted by the second changing magnetic field 3, acting orthogonal thereto, of the rotating permanent magnet 2. If the second changing magnetic field 3 of the rotating permanent magnet 2 is in parallel, the magnetic field 8.1 in the magnetic switch 1 is increased. In the used form, the material in the first gap 6 constitutes a body that can be magnetized in an anisotropic manner.

### REFERENCE SIGNS

1 Magnetic switching element
1.1 First ferromagnetic layer
1.2 Second ferromagnetic layer
1.3 Antiferromagnetic layer
2 Rotating permanent magnet
3 Second changing magnetic field
4 Yoke
4.1 First yoke portion
4.2 Second yoke portion
4.3 End face
5 Base laminate
5.1 Recess
5.2 Opening
6 First gap
7 Second gap
8 Permanent magnet
8.1 Magnetic field
9 Electrically conductive element
10 First changing magnetic field
11.1 First induction region
11.2 Second induction region
12 Permanent magnetic region
13 Permeability region

1.-11. (canceled)

12. A magnetic working circuit, wherein the working circuit comprises a magnetic circuit and a device arranged outside of the magnetic circuit for generating a changing external magnetic field that acts on a permeability region of the magnetic circuit, for a targeted and contactless change in a resultant effective magnetic permeability in a permeability region of the magnetic circuit and for topical provision of energy, and wherein the magnetic circuit
comprises a permanent magnetic region with a permanent magnetic material by which a magnetic field is provided in the magnetic circuit;
comprises the permeability region, a magnetic switching element being present in the permeability region and at least one material the magnetic permeability of which is changeable by the effect of a changing external magnetic field being present in the magnetic switching element; and
comprises one or more induction regions in which there is a magnetic flux change as a result of the effect of a change in the resultant effective permeability in the permeability region of the magnetic circuit and in the provided energy.

13. The magnetic working circuit of claim 12, wherein the magnetic switching element consists of a sequence of layers stacked above one another or next to one another, the sequence of layers comprising at least one first ferromagnetically hard layer with a first saturation flux density, followed by at least one either anti-ferromagnetic or ferromagnetically soft second layer and at least one ferromagnetically hard third layer with a third saturation flux density.

14. The magnetic working circuit of claim 13, wherein the first and third saturation flux densities have values in a range of from 400 to 600 mT.

15. The magnetic working circuit of claim 13, wherein the anti-ferromagnetic or ferromagnetically soft second layer has a second saturation flux density and the second saturation flux density ranges from 500 to 1000 mT.

16. The magnetic working circuit of claim 15, wherein the anti-ferromagnetic or ferromagnetically soft second layer has a second saturation flux density and the second saturation flux density ranges from 500 to 1000 mT.

17. The magnetic working circuit of claim 12, wherein the magnetic circuit comprises a yoke which is split into yoke portions by a first gap in the permeability region and by a second gap in the permanent magnetic region, the first gap and the second gap being respectively delimited by end faces of the yoke portions and
the magnetic switching element being arranged in the first gap and layers of the magnetic switching element being arranged extending parallel to the end faces of the yoke portions delimiting the first gap, and
a permanent magnet being arranged in the second gap.

18. The magnetic working circuit of claim 13, wherein the magnetic circuit comprises a yoke which is split into yoke portions by a first gap in the permeability region and by a second gap in the permanent magnetic region, the first gap and the second gap being respectively delimited by end faces of the yoke portions and
the magnetic switching element being arranged in the first gap and layers of the magnetic switching element being arranged extending parallel to the end faces of the yoke portions delimiting the first gap, and
a permanent magnet being arranged in the second gap.

19. The magnetic working circuit of claim 12, wherein the magnetic field caused by the permanent magnet and focused by a yoke which is split into yoke portions by a first gap in the permeability region and by a second gap in the permanent magnetic region, the first gap and the second gap being respectively delimited by end faces of the yoke portions, does not cause any of the first to third saturation flux densities in the first to third ferromagnetic layers of a magnetic switching element consisting of a sequence of layers stacked above one another or next to one another, at least one first ferromagnetically hard layer with a first saturation flux density being followed by at least one either anti-ferromagnetic or ferromagnetically soft second layer and at least one third ferromagnetically hard layer with a third saturation flux density.

20. The magnetic working circuit of claim 12, wherein an electrically conductive element is associated with at least one of the one or more induction regions and an electric voltage can be tapped in the at least one electrically conductive element as generated energy as a result of the effect of magnetic flux changes in the one or more induction regions.

21. The magnetic working circuit of claim 13, wherein an electrically conductive element is associated with at least one of the one or more induction regions and an electric voltage can be tapped in the at least one electrically conductive element as generated energy as a result of the effect of magnetic flux changes in the one or more induction regions.

22. The magnetic working circuit according to claim 18, wherein the magnetic working circuit is generated using LTCC (low-temperature cofired ceramic) technology.

23. The magnetic working circuit according to claim 19, wherein the magnetic working circuit is generated using LTCC technology.

24. The magnetic working circuit according to claim 20, wherein the magnetic working circuit is generated using LTCC technology.

25. The magnetic working circuit according to claim 21, wherein the magnetic working circuit is generated using LTCC technology.

26. A method for producing energy by a targeted change in a resultant effective magnetic permeability of a magnetic circuit or in a magnetically effective arrangement, in which a magnetic field is caused by a permanent magnetic material of a permanent magnetic region, by virtue of provided energy being supplied topically in a contactless manner to the magnetic circuit by the effect of a changing external magnetic field and a magnetic permeability of a material of the magnetic circuit being changed in a permeability region and generated energy being tapped at at least one induction region of the magnetic circuit.

27. The method according to claim 26, wherein the generated energy is tapped as electrical energy.

28. The method of claim 26, wherein the produced energy is generated by an occurring magnetocaloric effect and used thermodynamically.

29. The method of claim 27, wherein the produced energy is generated by an occurring magnetocaloric effect and used thermodynamically.
